(19) United States
(12) Patent Application Publication
(10) Pub. No.: US 2024/0232877 A1
(43) Pub. Date: Jul. 11, 2024

(54) NON-FUNGIBLE TOKEN (NFT)-DISTRIBUTED EVENTS FOR PEER-TO-PEER EXCHANGE

(71) Applicant: INTERNATIONAL BUSINESS MACHINES CORPORATION, ARMONK, NY (US)

(72) Inventors: Zachary A. Silverstein, Georgetown, TX (US); Jacob Ryan Jepperson, St. Paul, MN (US); Melanie Dauber, Oceanside, NY (US); Jeremy R. Fox, Georgetown, TX (US); Logan Bailey, Atlanta, GA (US)

(21) Appl. No.: 18/153,052

(22) Filed: Jan. 11, 2023

(51) Int. Cl. G06Q 20/38; G06Q 20/36; G06Q 20/42

(52) U.S. Cl. CPC G06Q 20/389; G06Q 20/36; G06Q 20/42; G06Q 2220/10

(57) ABSTRACT

A method, computer system, and computer program product for event NFT distribution is provided. The embodiment may include generating, in response to a user registering an event with a provider, a unique non-fungible token (NFT), where the NFT includes information associated with the event recorded on a blockchain. The embodiment may also include, responsive to receiving an indication from the user to modify the event, identifying additional NFT owners that the user is permitted to communicate with over a blockchain-based messaging protocol, where the additional NFT owners are identified based on a set of service provider criteria associated with the NFT, and establishing a blockchain-based messaging session with the user and one or more of the permitted additional NFT owners. The embodiment may further include, responsive to the user and an additional NFT owner agreeing to transfer NFTs, recording the transferred NFTs on the blockchain without confirmation from the provider.

### BACKGROUND

The present invention relates generally to the field of computing, and more particularly to non-fungible tokens (NFTs).

NFTs are unique digital assets sold, exchanged, and/or purchasable in an online marketplace. Typically, NFTs represent the digitized form of a real-life entity, such as artwork, music, images, and videos, but may have seemingly boundless uses. NFTs are accompanied by unique identification codes that are linked to a blockchain, which results in the non-fungibility of the digital asset. Since only a single entity with the specific identification code exists on the blockchain, scarcity is created and, thus, supply of the digital asset is limited. Generally, NFTs are available for purchase on a marketplace with fungible assets, such as cryptocurrencies. For example, an NFT representing a painting may be bid upon on a digital auction website with the Ethereum blockchain cryptocurrency Ether.

### SUMMARY

According to one embodiment, a method, computer system, and computer program product for event NFT distribution is provided. The embodiment may include generating, in response to a user registering an event with a provider, a unique non-fungible token (NFT), where the NFT includes information associated with the event recorded on a blockchain. The embodiment may also include, responsive to receiving an indication from the user to modify the event, identifying additional NFT owners that the user is permitted to communicate with over a blockchain-based messaging protocol, where the additional NFT owners are identified based on a set of service provider criteria associated with the NFT, and establishing a blockchain-based messaging session with the user and one or more of the permitted additional NFT owners, where the blockchain-based messaging session allows for transferring of NFTs generated for respective events with the service provider. The embodiment may further include, responsive to the user and an additional NFT owner within the permitted additional NFT owners agreeing to transfer NFTs, recording the transferred NFTs on the blockchain without confirmation from the provider.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIGS. 2A-2B illustrate an operational flowchart for a non-fungible token (NFT) event exchange process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to non-fungible tokens (NFTs) and reservation systems. The following described exemplary embodiments provide a system, method, and program product to, among other things, implement a peer-to-peer (P2P) exchange of NFTs representative of scheduled reservations for individual users with entity. Therefore, the present embodiment has the capacity to improve the technical field of NFTs and reservation systems by implementing a P2P decentralized environment that allows the exchange of reservation times without requiring provider engagement as well as avoids the necessity for a provider to self-heal or absorb the loss of a changed reservation.

As previously described, NFTs are unique digital assets sold, exchanged, and/or purchasable in an online marketplace. Typically, NFTs represent the digitized form of a real-life entity, such as artwork, music, images, and videos, but may have seemingly boundless uses. NFTs are accompanied by unique identification codes that are linked to a blockchain, which results in the non-fungibility of the digital asset. Since only a single entity with the specific identification code exists on the blockchain, scarcity is created and, thus, supply of the digital asset is limited. Generally, NFTs are available for purchase on a marketplace with fungible assets, such as cryptocurrencies. For example, an NFT representing a painting may be bid upon on a digital auction website with the Ethereum blockchain cryptocurrency Ether. However, NFTs may be distributed, optionally at no cost, by any entity wishing to utilize a blockchain to securely register an intangible to an individual or other entity.

Many providers require scheduling ahead before an event, such as a meeting, reservation, or appointment, is conducted. Common examples include, but are not limited to, doctor's office visits, interviews, meals, and networking at convention events. However, in modern society, unexpected items arise that may require the rescheduling of an earlier agreed-upon event. In such situations, the provider (e.g., the interviewer, networker, etc.) may be required to either absorb the loss by not filling the time vacancy or self-healing by trying to find another individual to fill the now open time slot for the event. For example, a networker at a convention that had many individuals scheduled to meet with on a given day may have a last-minute cancellation and is in need of finding another individual to fill that time vacancy or accept the loss by speaking with one less networking contact. In some situations, the burden on the provider in such situations may be substantial in a single, significant event lost or in the aggregation of multiple, more minor lost events. As such, it may be advantageous to, among other things, develop a decentralized P2P solution that allows recipients to exchange scheduled events without requiring the engagement of the provider.

According to one embodiment, an NFT distributed event program may generate a digital tokenized asset (i.e., an NFT) persisting on a distributed ledger or blockchain when an event is originated. The NFT distributed event program then issue the generated NFT to an individual who requested the event as a unique identifier that the individual is the authorized recipient in the event with the provider. In situations where a modification of the original time and/or date of the event is required, the NFT distributed event program may allow the NFT bearer wishing to modify the event to engage other NFT holders in an effort to facilitate a P2P exchange of NFTs, and thus the events of which the NFTs are representative, without creating a burden or loss for the provider. In at least one other embodiment, the NFT distributed event program may allow an NFT bearer to engage with third party, non-NFT holders, as opposed to or in addition to other NFT holders, when the NFT bearer wishes to cancel the event that the NFT represents. In doing so, the non-NFT holder may obtain a right to attend the previously arranged event in place of the original NFT bearer.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

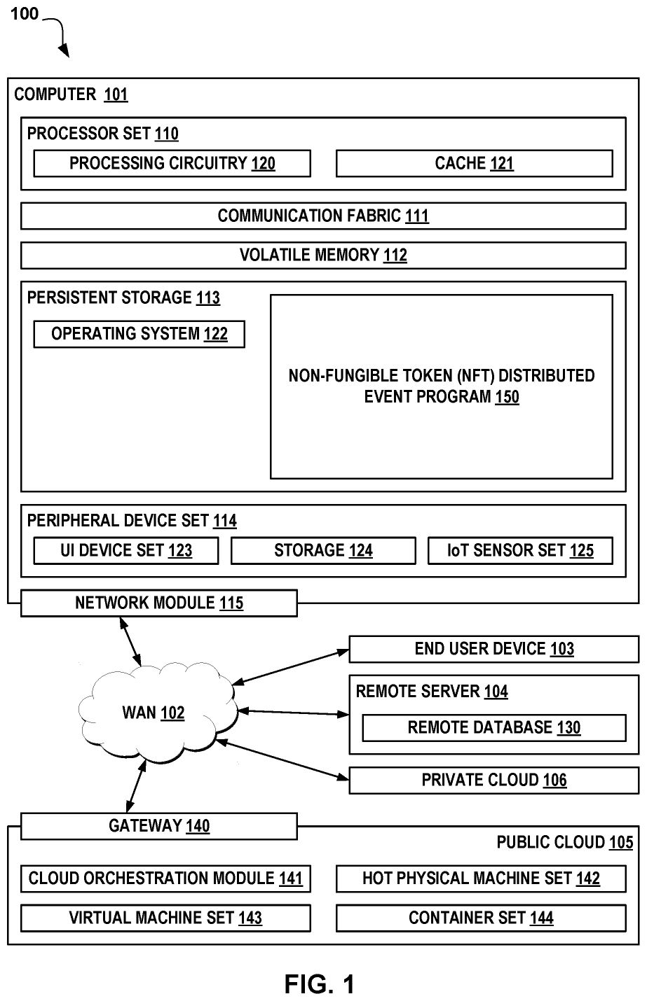

Referring now to FIG. 1, computing environment 100 contains an example of an environment for the execution of at least some of the computer code involved in performing the inventive methods, such as NFT distributed event program 150. In addition to NFT distributed event program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and NFT distributed event program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in NFT distributed event program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in NFT distributed event program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

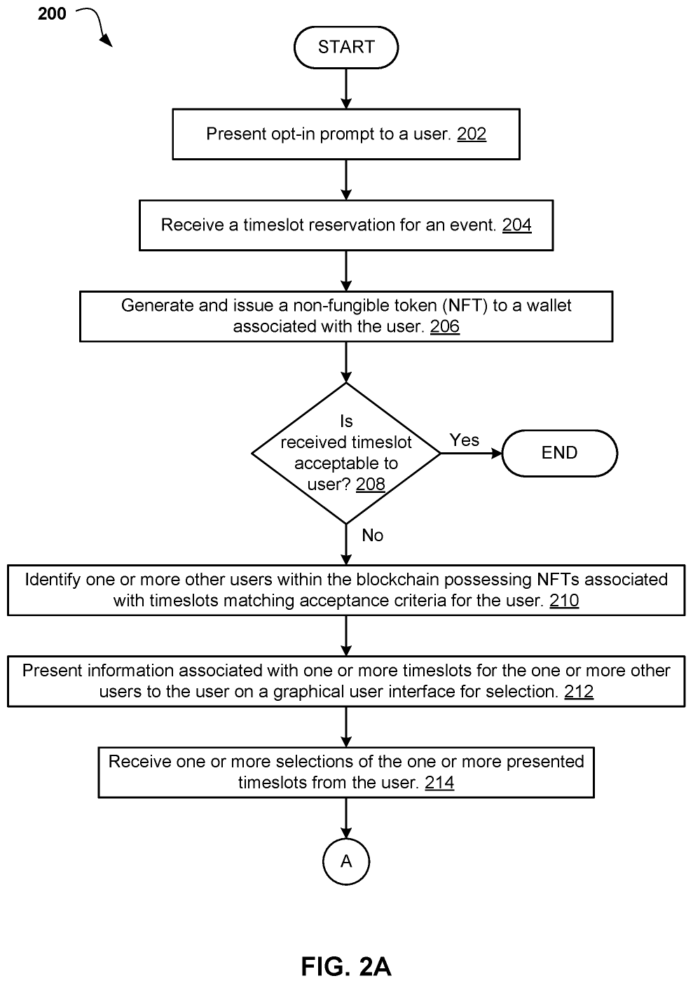

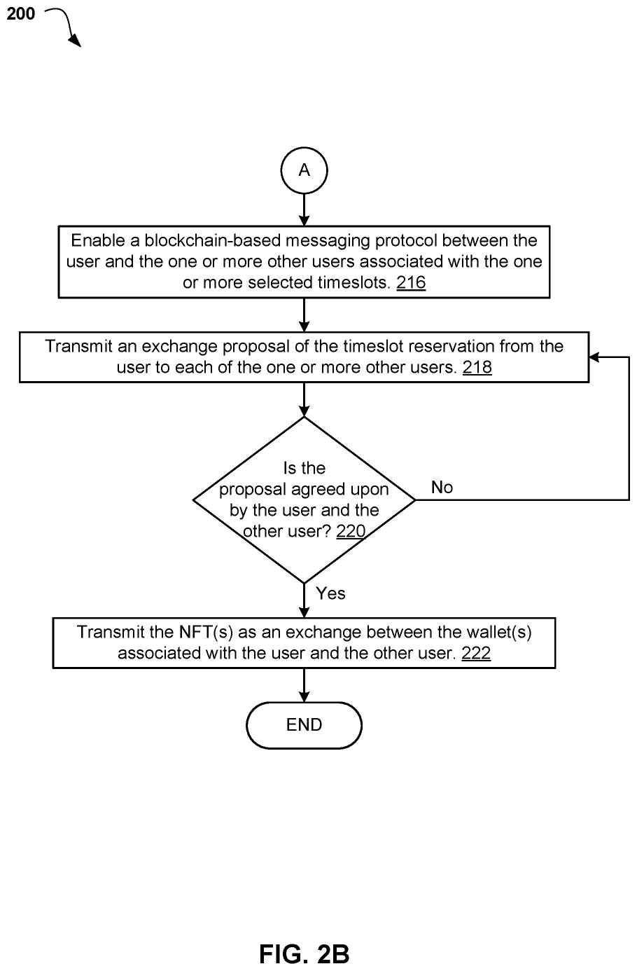

According to at least one embodiment, the NFT distributed event program 150 may upon the successful establishment of an event, generate an NFT on a decentralized blockchain that commemorates and grants the user holding the NFT a right to the scheduled event with the issuer of the NFT. Once the NFT is generated on the blockchain, the NFT distributed event program 150 may issue the generated NFT to the user requesting the event. If at any point the user determines a change to the scheduled event is necessary for any reason (e.g., newly arisen scheduling conflict, illness, emergency, etc.), the NFT distributed event program 150 may enable the user to interface with the blockchain through a graphical user interface to identify one or more other users holding NFTs representative of other events with the issuer. The NFT distributed event program 150 may identify the one or more other users based on characteristics that the user is looking for in a rescheduled appointment, such as a specific time of day or day of the week. In at least one embodiment, where the user is seeking to cancel the scheduled event, the NFT distributed event program 150 may allow the user to engage with non-NFT-bearing third parties seeking to obtain an event with the issuer. Once an exchange of events is authorized, the NFT distributed event program 150 may execute the transfer of the NFT(s) from each individual in possession of an NFT to the corresponding party to receive the respective NFT(s) across the blockchain. Furthermore, notwithstanding depiction in computer 101, the NFT distributed event program 150 may be stored in and/or executed by, individually or in any combination, end user device 103, remote server 104, public cloud 105, and private cloud 106. The predictive yield method is explained in more detail below with respect to FIGS. 2A and 2B.

Referring now to FIGS. 2A and 2B, an operational flowchart for a non-fungible token (NFT) event exchange process 200 is depicted according to at least one embodiment. In

FIG. 2A, at 202, the NFT distributed event program 150 may present an opt-in prompt to a user. The NFT distributed event program 150 may require each user to opt-in through an opt-in procedure before scheduling an event, such as a meeting, reservation, or appointment, with a provider. The opt-in procedure may include, but is not limited to, presenting, on a graphical user interface, a disclosure of any information that may be collected and shared with the NFT distributed event program 150 through the NFT event exchange process 200 and detailed information as to the length of time the collected information may be stored. Furthermore, the opt-in procedure may require each user to manually confirm each presented disclosure and record such confirmation in a repository, such as storage 124 and/or remote database 130.

Then, at 204, the NFT distributed event program 150 may receive a timeslot reservation for an event. When a user wishes to schedule an event with a provider, the user may reserve a timeslot for the event in one of several manners including, but not limited to, in-person registration with the provider, telephonic registration with the provider, and online electronic registration with the provider. In-person and/or telephonic registration may take place through interactions with a provider representative. However, online electronic registration may occur through user interactions with a graphical user interface. Online electronic registration may include a presentation of each available timeslot the provider is available for a preconfigured period of time in the future. For example, if a user is attempting to schedule a networking meeting with a provider representative at a convention, the NFT distributed event program 150 may display available timeslots for each day the representative is present at the convention.

Next, at 206, the NFT distributed event program 150 may generate and issue an NFT to a wallet associated with the user. Upon the user selecting and registering a timeslot for the provider, the NFT distributed event program 150 may generate an NFT representative of the event and all relevant information for the event including, but not limited to, event time, provider name, services to be rendered during the event, and a QR code link. The NFT distributed event program 150 may issue the NFT utilizing any standard or non-standard interface that allows for control of any number of fungible and/or non-fungible token types existing on a blockchain or distributed ledger. The generated NFT may allow any related transaction data to be stored either on the blockchain ledger directly and/or indirectly via off chain storage retrievable via utilization of an on-chain URI mapped to the unique token id. In order to maintain user anonymity and adequately store user personal information, the NFT distributed event program 150 may maintain a parallel side chain or off-chain database, such as remote database 130, for the provider. Additionally, in at least one embodiment, the provider may embed, in the metadata of the NFT, specific criteria for NFT exchanges occurring on either primary or secondary exchanges.

Once the NFT is generated, the NFT distributed event program 150 may issue the NFT to the user's wallet. The user's wallet may be a third party, custodial wallet managed by the provider. In at least one embodiment, the NFT distributed event program 150 may allow each user to transfer the generated NFT to a personal hardware wallet.

Next, at 208, the NFT distributed event program 150 may determine whether the received timeslot is acceptable to the user. In one embodiment, the NFT distributed event program 150 may randomly assign a timeslot to each user upon the user initiating a request to reserve a timeslot with the provider. In such a situation, the NFT distributed event program 150 may present the user with a confirmation dialog box on a graphical user interface for the user to provide confirmation or disagreement with the issued timeslot. Depending on the option chosen by the user, the NFT distributed event program 150 may determine that the received timeslot is acceptable or is not acceptable.

In another embodiment, the NFT distributed event program 150 may monitor user accounts on various platforms over a period of time to determine whether the received timeslot is acceptable to the user. For example, the NFT distributed event program 150 may monitor a user personal calendar and a user business calendar on one or more software platforms, such as remote server 104, public cloud 105, and/or private cloud 106. If the NFT distributed event program 150 determines that a conflict has arisen in based on newly added events to the user accounts on the various platforms, the NFT distributed event program 150 may present a prompt to the user to request whether the event remains acceptable to the user at the current timeslot.

If the NFT distributed event program 150 determines the received timeslot is acceptable (step 208, “Yes” branch), then the NFT event exchange process 200 may end. If the NFT distributed event program 150 determines the received timeslot is not acceptable or no longer acceptable (step 208, “No” branch), then the NFT event exchange process 200 may continue to step 208 to identify one or more other users within the blockchain possessing NFTs associated with timeslots matching acceptance criteria for the user.

Then, at 210, the NFT distributed event program 150 may identify one or more other users within the blockchain possessing NFTs associated with timeslots matching acceptance criteria for the user. Once the NFT distributed event program 150 determines that the received timeslot for the event is unacceptable, or no longer acceptable, to the user, the NFT distributed event program 150 may proceed with identifying one or more other users with whom an exchange of timeslots may be beneficial and/or warranted. The NFT distributed event program 150 may utilize one or more criteria to search for the one or more other users. For example, users associated with NFTs corresponding to a specific time frame or a specific date or day of the week. The one or more criteria may be preconfigured and/or defined by the user when the timeslot currently associated with the user's NFT is deemed unacceptable.

The NFT distributed event program 150 may also identify the one or more other individuals through a check-in process. For example, when the NFT distributed event program 150 identifies the timeslot is no longer acceptable to the user, or any of the one or more other users, the NFT distributed event program 150 may add each user or the NFT associated with each user to a repository list. If the timeslot is subsequently transferred to another user or reestablishes as acceptable to the user, the NFT distributed event program 150 may remove the user and/or the NFT associated with the user from the repository list.

In at least one other embodiment, the NFT distributed event program 150 may tag the timeslot acceptability in the metadata information of the NFT similar to information included in the NFT at the time of generation. Therefore, if the NFT distributed event program 150 determines the timeslot is no longer acceptable to the user, the NFT distributed event program 150 may conduct a search across the blockchain for each NFT with a similar tag and effectuate a messaging interface between users according to step 212.

Next, at 212, the NFT distributed event program 150 may present information associated with one or more timeslots for the one or more other users to the user on a graphical user interface for selection. Once the one or more other users are identified, the NFT distributed event program 150 may present the timeslot information associated with the NFTs of the one or more other users. When presenting the timeslot information, the NFT distributed event program 150 may maintain confidentiality and/or anonymity of the one or more other users unless otherwise agreed upon by the one or more other users to disclose and share such information.

The NFT distributed event program 150 may present the information associated with the one or more timeslots to the user through one or more presentation styles. For example, the timeslots may be displayed on an interactive calendar or in a spreadsheet format.

Then, at 214, the NFT distributed event program 150 may receive one or more selections of the one or more presented timeslots from the user. The NFT distributed event program 150 may allow the user to interact with the timeslots presented through the one or more presentation styles in order to identify a specific NFT associated with a timeslot that the user wishes to exchange with another user. The NFT distributed event program 150 may allow selection of the timeslot though one or more devices listed in UI device set 123.

Referring now to FIG. 2B, at 216, the NFT distributed event program 150 may enable a blockchain-based messaging protocol between the user and the one or more other users associated with the one or more selected timeslots. The NFT distributed event program 150 may utilize the blockchain-based messaging protocol to allow the user to communicate with other NFT holders based on allowed acceptance criteria. In another embodiment, the NFT distributed event program 150 may utilize possession of the NFT to allow wallets and/or NFT's to act as a private key to message other holders. In some other embodiments, these criteria may be uncapped or it may be selected by the provider such as other NFTs that represent meetings within a specified timeframe of the possessed NFT.

Next, at 218, the NFT distributed event program 150 may transmit an exchange proposal of the timeslot reservation for the user to each of the one or more other users. Once a specific timeslot, and therefore the accompanying NFT for that timeslot, has been identified and a request for exchange is prepared, the NFT distributed event program 150 may transmit the request to the owner of the NFT with which the user wishes to exchange. The NFT distributed event program 150 may use the engagement by the user with another user, or the transmission of the exchange proposal, to initiate a notification to the other user that an exchange request is present for the NFT within the other user's wallet.

Then, at 220, the NFT distributed event program 150 may determine whether the proposal is agreed upon by the user and the other user. The NFT distributed event program 150 may determine that the exchange proposal is agreed upon by the other user's acknowledgement to perform the exchange for the user's NFT. If the NFT distributed event program 150 determines the exchange proposal is agreed upon by the user and the other user (step 220, “Yes” branch), then the NFT event exchange process 200 may proceed to step 222 to transmit the NFT(s) as an exchange between the wallet(s) associated with the user and the other user. If the NFT distributed event program 150 determines the exchange proposal is not agreed upon by the user and the other user (step 220, “No” branch), then the NFT event exchange process 200 may return to step 218 to transmit an exchange proposal of the timeslot reservation from the user of each of the one or more other users. In at least one embodiment, in a repeat of step 218 once the other user has not agreed upon the initial exchange proposal, a subsequent exchange proposal may be initiated from the other user.

Then, at 222, the NFT distributed event program 150 transmits the NFT(s) as an exchange between the wallet(s) associated with the user and the other user. Once an exchange is agreed upon by the users, the NFT distributed event program 150 may effectuate a transfer of the NFTs to each user's associated wallet. The transferring of NFTs may provide the necessary desired flexibility in a decentralized manner without going through a central provider, which may improve timeliness and the reduction of computing resources. During the exchange process, the NFT distributed event program 150 may validate transferring of NFTs on the P2P market and pass the information back to a watcher node (e.g., to the provider).

It may be appreciated that FIGS. 2A and 2B provide only an illustration of one implementation and do not imply any limitations with regard to how different embodiments may be implemented. Many modifications to the depicted environments may be made based on design and implementation requirements. For example, although previously described as the transferring of NFTs between two NFT holders, the NFT distributed event program 150 may also operate in a situation where a single NFT holder wishes to transfer the NFT, and the associated event timeslot, to a non-NFT holder. Such may occur when the NFT holder wishes to cancel the scheduled event with the provider and a non-NFT holder wishes to schedule the same event, which may oftentimes be time sensitive and/or urgent. The NFT distributed event program 150 may allow the NFT holder to interact with non-NFT holders through the same blockchain-based messaging protocol or through a non-blockchain-based messaging protocol since non-NFT holders may not have access to the advantages of the blockchain-based messaging protocol for not being NFT holders. Once a transmission from the NFT holder to the non-NFT holder is agreed upon, the NFT distributed event program 150 may generate a new wallet, or transfer to an existing wallet, and transmit the NFT from the NFT holder to the non-NFT holder.

In another embodiment, the NFT distributed event program 150 may be adopted and further adapted to a metaverse-style social collaboration calendar engagement. The combination of physical and virtual meetings and appointments may provide an optimal scope for focus within another additional embodiment. Additionally, a hybrid-style appointment could encounter the ability to observe and reserve a user's time within the physical world to allow them the time and virtual space to engage within the interaction with others within the metaverse. Furthermore, the correlation of all participating parties (N+1) within the metaverse environment could be considered.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
generating, in response to a user registering an event with a provider, a unique non-fungible token (NFT), wherein the NFT includes information associated with the event recorded on a blockchain;
responsive to receiving an indication from the user to modify the event:
identifying additional NFT owners that the user is permitted to communicate with over a blockchain-based messaging protocol, wherein the additional NFT owners are identified based on a set of provider criteria associated with the NFT; and
establishing a blockchain-based messaging session with the user and one or more of the permitted additional NFT owners, wherein the blockchain-based messaging session allows for transferring of NFTs generated for respective events with the provider; and
responsive to the user and an additional NFT owner within the permitted additional NFT owners agreeing to transfer NFTs, recording the transferred NFTs on the blockchain without confirmation from the provider.

2. The method of claim 1, wherein the NFT allows a user wallet or the NFT to act as a private key to message other NFT owners via the blockchain-based messaging protocol.

3. The method of claim 1, wherein the blockchain-based messaging session is part of a peer-to-peer market.

4. The method of claim 3, wherein information associated with transferred NFTs is communicated to a provider network after the NFT transfer is validated by the blockchain.

5. The method of claim 1, wherein recording the transferred NFTs further comprises:
validating the transferred NFTs; and
transmitting information about the recordation and the validation to a watcher node.

6. The method of claim 1, wherein the NFT includes metadata, embedded upon the generation and according to direction by the provider, that establishes specific criteria for NFT exchanges between owners on either primary exchanges or secondary exchanges.

7. The method of claim 1, wherein information associated with the event is selected from a group consisting of an event time, a provider name, services to be rendered during the event, and a QR code link.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating, in response to a user registering an event with a provider, a unique non- fungible token (NFT), wherein the NFT includes information associated with the event recorded on a blockchain;
responsive to receiving an indication from the user to modify the event:
identifying additional NFT owners that the user is permitted to communicate with over a blockchain-based messaging protocol, wherein the additional NFT owners are identified based on a set of provider criteria associated with the NFT; and
establishing a blockchain-based messaging session with the user and one or more of the permitted additional NFT owners, wherein the blockchain-based messaging session allows for transferring of NFTs generated for respective events with the provider; and
responsive to the user and an additional NFT owner within the permitted additional NFT owners agreeing to transfer NFTs, recording the transferred NFTs on the blockchain without confirmation from the provider.

9. The computer system of claim 8, wherein the NFT allows a user wallet or the NFT to act as a private key to message other NFT owners via the blockchain-based messaging protocol.

10. The computer system of claim 8, wherein the blockchain-based messaging session is part of a peer-to-peer market.

11. The computer system of claim 10, wherein information associated with transferred NFTs is communicated to a provider network after the NFT transfer is validated by the blockchain.

12. The computer system of claim 8, wherein recording the transferred NFTs further comprises:
validating the transferred NFTs; and
transmitting information about the recordation and the validation to a watcher node.

13. The computer system of claim 8, wherein the NFT includes metadata, embedded upon the generation and according to direction by the provider, that establishes specific criteria for NFT exchanges between owners on either primary exchanges or secondary exchanges.

14. The computer system of claim 8, wherein information associated with the event is selected from a group consisting of an event time, a provider name, services to be rendered during the event, and a QR code link.

15. A computer program product, the computer program product comprising:
one or more computer-readable tangible storage medium and program instructions stored on at least one of the one or more tangible storage medium, the program instructions executable by a processor capable of performing a method, the method comprising:
generating, in response to a user registering an event with a provider, a unique non- fungible token (NFT), wherein the NFT includes information associated with the event recorded on a blockchain;
responsive to receiving an indication from the user to modify the event:
identifying additional NFT owners that the user is permitted to communicate with over a blockchain-based messaging protocol, wherein the additional NFT owners are identified based on a set of provider criteria associated with the NFT; and
establishing a blockchain-based messaging session with the user and one or more of the permitted additional NFT owners, wherein the blockchain-based messaging session allows for transferring of NFTs generated for respective events with the provider; and
responsive to the user and an additional NFT owner within the permitted additional NFT owners agreeing to transfer NFTs, recording the transferred NFTs on the blockchain without confirmation from the provider.

16. The computer program product of claim 15, wherein the NFT allows a user wallet or the NFT to act as a private key to message other NFT owners via the blockchain-based messaging protocol.

17. The computer program product of claim 15, wherein the blockchain-based messaging session is part of a peer-to-peer market.

18. The computer program product of claim 17, wherein information associated with transferred NFTs is communicated to a provider network after the NFT transfer is validated by the blockchain.

19. The computer program product of claim 15, wherein recording the transferred NFTs further comprises:
validating the transferred NFTs; and
transmitting information about the recordation and the validation to a watcher node.

20. The computer program product of claim 15, wherein the NFT includes metadata, embedded upon the generation and according to direction by the provider, that establishes specific criteria for NFT exchanges between owners on either primary exchanges or secondary exchanges.
